(19) United States
(12) Patent Application Publication
(10) Pub. No.: US 2025/0217735 A1
(43) Pub. Date: Jul. 3, 2025

(54) SYSTEM AND METHOD FOR MANAGING WORK MACHINES ON TROLLEYS

(71) Applicant: Caterpillar Inc., Peoria, IL (US)

(72) Inventors: Russell A. Brockhurst, Carindale (AU); Kenneth Patrick Robinson, Brisbane (AU)

(73) Assignee: Caterpillar Inc., Peoria, IL (US)

(21) Appl. No.: 18/399,021

(22) Filed: Dec. 28, 2023

(51) Int. Cl. G06Q 10/0631; G06Q 30/018

(52) U.S. Cl. CPC G06Q 10/06313; G06Q 30/018

(57) ABSTRACT

This disclosure describes, in part, systems and methods for dynamic allocation, monitoring, and reallocation of work machines at a worksite by using a controller to monitor ranked production circuits and dynamically reallocate work machines based on their energy consumption, energy availability, machine operating parameters, flow rates, delays, wait times, and other such factors to provide compliance with the ranked production plan. The controller is used to determine slow-downs, delays, queues, or other potential delays, including insufficient energy availability for a particular work machine distribution, and to dynamically adjust to provide for work machines to reduce empty travel time and to maintain material flow rates or other metrics of the production plan.

### TECHNICAL FIELD

The present description relates generally to systems and methods for dispatching vehicles, and more particularly, to systems and methods for dispatching work machines between loading and unloading areas in a surface mining operation.

### BACKGROUND

Certain applications, such as strip mining, involve the transportation of aggregate material, such as ore, from a mining site to a processing or shipping facility. Typical mining operations use guided work machines that carry the extracted material from an extraction area or material source to a deposition area or a dump. A typical large scale mining operation may include more than one material source and more than one dump. The work machines used to transport the material may be autonomously guided, e.g., operate without a driver, and may perform hundreds of trips daily as some mining operations operate around the clock. The loading of the aggregate material onto the work machines is typically accomplished by use of wheeled loaders or excavators, material conveyors, shovels, underground loading chutes, and the like.

For many large commercial mining operations, maximization of equipment utilization is desired to achieve business objectives. The business objectives may include profits, minimization of wear and tear on equipment, working according to a mine plan, and other such objective. The maximization of equipment utilization, especially in the case of autonomously guided vehicles, requires efficient dispatching of the work machines to the various loading and unloading stations. Various methods have been proposed in the past to optimize work machine dispatching. For example, manual dispatch may be used to direct the work machines to the most efficient task or process at any given time. As can be appreciated, however, manual dispatch may not be as efficient as an automated process that performs the same function.

Another type of dispatch is a so-called “restricted” automatic dispatch, in which work machines are dispatched automatically based on restrictions defined by controllers of the mining site. Such restrictions may include rules or limitations on work machine assignments such as limiting a specific work machine to a specific loading tool or dump. If such restrictions are removed, automatic dispatch can be used in which work machines are dispatched automatically to achieve defined business objectives, such as to maximize production within the constraints of a daily production plan.

While the manual dispatch of work machines may be used effectively at small mine sites, complexity increases dramatically with mine site size making the manual dispatch of Work machines for large sites impractical. Restricted automatic dispatch can be used effectively at larger mine sites provided that mine controllers are vigilant and continuously manage the restrictions to optimize production. The preferred solution is to move to fully automatic dispatch so that mine operations may be optimized without the need for continuous intervention by mine controllers.

An automatic dispatch system may include a multi-phase optimization of haul truck dispatch that periodically produces a production plan, based on a user's production target at a mine. The system dispatches haul trucks in near real time based on the production plan. When a haul truck is loaded at a loading tool, its next assignment is constrained by the production plan. When the haul truck dumps its payload at the processor, it is automatically assigned to the neediest loading tool, that is, to the loading tool that is more immediately ready to carry out a loading operation, a loading tool having a higher priority that other loading tools, and the like.

Some approaches may provide various solutions. For example, US20090327011A1 describes that “ . . . the optimum schedule defining the number of trips taken along paths between the destination locations and the source locations H achieve the optimum production;” and WO2016118122A1, which describes that “Work machine assignment as a part of a dispatching system has a role to determine the number of work machines from each fleet that should be operating between any loading tools (loaders, shovels) and dumping locations (dumps) to meet production requirements.”

Previous solutions that used optimization based on a production plan that included only loaded travel has revealed that fully automated dispatch was unable to reliably achieve total production or compliance with a production plan. Because the production plan was defined only by loaded travel, the near real time assignment of haul trucks was sub-optimal, especially with respect to return legs. In such previous systems and methods, haul trucks were occasionally dispatched to return travel legs that were long, which detracted from the production capability of all assets involved and was not optimal with respect to satisfying aggressive production plans. Each assignment to a return leg that was not contemplated in the production plan constituted waste of resources, or lost production, which made it more difficult for the system to achieve the defined production plan.

In some instances, the production plan may be defined as a ranked set of production circuits (e.g., a portion of a production plan that considers both loaded and empty travel to define a sequence of activities to be performed one or more times by an individual work machine that includes at least one loading activity and one dumping activity). In some examples, such as when production circuits persist over time, random events or interruptions may cause variations in machine arrival times that may result in bunching, queuing, reduced blend tolerance, gaps in material flows, excessive peak use of charging infrastructure, and other such events.

Examples of the present disclosure are directed toward overcoming the deficiencies described above.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a system for allocating work machines to production circuits at a worksite. The system includes a central controller communicably coupled with a plurality of production circuits, each of the production circuits may include at least one extraction area or material source and at least one dump area, and the controller may include one or more processors; and one or more non-transitory computer-readable media having instructions stored thereon that, when executed by the one or more processors, cause the one or more processors to perform various operations. In some examples, the processes and techniques described herein may be performed by a computing device on-board a work machine and/or a computing device separate from the work machines. The operations may include determining and/or planning a plurality of production circuits for the worksite, the production circuits including one or more production arcs and one or more return arcs between loading areas and dumping areas. The operations may include determining a production plan, allocating resources based on the production plan, and assigning or dispatching the resources according to the allocation. The operations may also include determining a production plan for the worksite, the production plan including a ranked ordering of the plurality of production circuits and determining a first allocation of a plurality of work machines to the plurality of production circuits based at least in part on the production plan. The operations further include causing the plurality of work machines to distribute to the plurality of production circuits based at least in part on the first allocation and subsequently determining a compliance score describing compliance with the production plan based at least in part on production data describing activity of the plurality of work machines. The operations further include determining a second allocation of the plurality of work machines based at least in part on the production plan and the compliance score and causing the plurality of work machines to distribute to the plurality of production circuits based at least in part on the second allocation.

One general aspect includes a method for allocating work machines at a worksite. The method includes determining, by a processor, a plurality of production circuits for the worksite, the production circuits may include a series or set of activities that may be repeated one or more times at a worksite, in one example the production circuits may include one or more production arcs and one or more return arcs between loading areas and dumping areas. The method also includes determining, by the processor, a production plan for the worksite, the production plan may include a ranked ordering of the plurality of production circuits. The method also includes determining, by the processor, a first allocation of a plurality of work machines to the plurality of production circuits based at least in part on the production plan and causing, by the processor, the plurality of work machines to distribute to the plurality of production circuits based at least in part on the first allocation. The method also includes determining, by the processor, a compliance score describing compliance with the production plan based at least in part on production data describing activity of the plurality of work machines. The method also includes determining, by the processor, a second allocation of the plurality of work machines based at least in part on the production plan and the compliance score and causing, by the processor, the plurality of work machines to distribute to the plurality of production circuits based at least in part on the second allocation. Other embodiments of this aspect include corresponding computer systems, apparatus, and computer programs recorded on one or more computer storage devices, each configured to perform the actions of the methods.

The method may also include determining and/or dispatching resources, such as work machines according to the allocation determined herein. The dispatch process may include assigning work machines to execute a next step in one of their allocated production circuits. In some examples, the dispatch process may include temporary reassignments or diversions from allocated productions circuits. The diversions may include diverting to charge a battery of a battery-electric machine, to fuel (e.g., for diesel-powered vehicles), to travel to a maintenance location, travel to a weigh scale, travel to an overhead gantry, or other such interim destination.

In some examples, the methods described herein may be applied to mining sites, as illustrated throughout. In some examples, the methods described herein may also be applied to different types of work machines that perform different operations and activities and that may include, inclusively, water trucks, graders, dozers, wheel loaders, and other such equipment. For other machine types, references to loading activities, dumping activities and other activities specific to haul trucks discussed herein may be replaced with other activities appropriate for the other machine types such as watering, grading, clean-up, pushing, loading, and other such activities.

### BRIEF DESCRIPTION OF FIGURES

The detailed description is set forth with reference to the accompanying figures. The use of the same reference numbers in different figures indicates similar or identical items or features.

FIG. 1 is a schematic view of a mining site in accordance with the disclosure.

FIG. 2 is a block diagram of a dispatch system in accordance with a first embodiment of the disclosure.

FIGS. 3-6 are block diagrams of various example mining site operation conditions in accordance with the disclosure.

FIG. 7 is a block diagram of a dispatch system in accordance with a second embodiment of the disclosure.

FIG. 8 is a flowchart of a method of allocating and reallocating work machines in a mining site in accordance with the disclosure.

### DETAILED DESCRIPTION

Wherever possible, the same reference numbers will be used throughout the drawings to refer to the same or like parts.

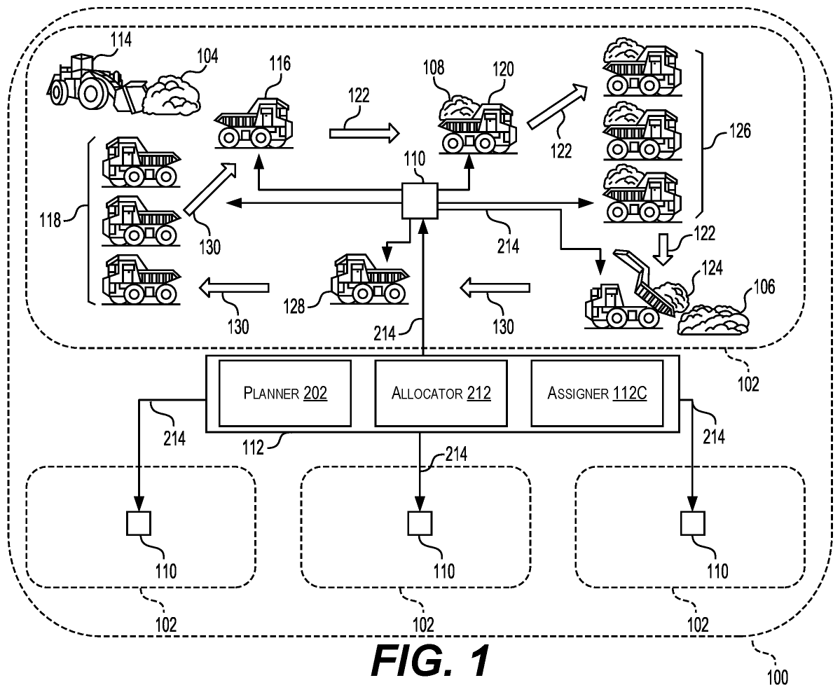

Referring now to the drawings and with specific reference to FIG. 1, the present description relates to systems and methods for dispatch of assets in a work area such as a mining site 100. The assets contemplated herein include assets such as work machines 108 that may be used to transport material from one or more material production areas to one or more material consumption areas. In some examples, the assets may include additional work machines such as loaders 114 and other production or processing equipment. The particular implementations of the systems and methods to a mining site 100 are described herein as exemplary embodiments to illustrate various aspects of the disclosure. In the embodiments described, work machines are dispatched by the system automatically to carry mined aggregates between loader locations and dump locations. In certain embodiments, the systems and methods also dictate or specify the particular travel path from the dump locations to the loading locations that the work machines will use.

The mining site 100 may include one or more production circuits 102. production circuit 102 may include any number of activities. For instance, FIG. 1 shows an example in which a production circuit 102 includes activities for loading and dumping work machines. However, a production circuit 102 may include fewer activities, or more activities, than shown in FIG. 1. For instance, in some examples, different production circuits may include different numbers of activities.

A planner 202 and allocator 212 associated with the mining site 100 may assign the work machines 108 to one or more production circuits 102. The allocator 212 may have predefined information associated with production circuits 102, such as information that defines the activities, sequence of activities, and priority of activities associated with each of the production circuits 102. The allocator 212 may assign work machines 108 to one or more of the production circuits 102 to define production circuit allocations 110 (e.g., a set of machines assigned to each production circuit).

For example, the allocator 212 may transmit production circuit assignment data to the work machines 108 so that the work machines 108 may execute the production circuit independently with no need for an independent near real-time assigner 112C. The production circuit assignment data may identify one or more production circuits 102 to which the work machine 108 is assigned. The production circuit assignment data may also indicate information associated with individual activities of corresponding production circuits 102.

The allocator 212 may assign one or more work machines 108 at the mining site 100 to the same production circuit 102 and/or to different production circuits 102. Although an example of one production circuit 102 is shown in FIG. 1, the allocator 212 may assign a work machine 108 to a ranked list of production circuits 102. Additionally, the allocator 212 may assign different work machines 108 at the mining site 100 to the same production circuit 102 and/or to different production circuits 102.

Different production circuits 102 may include different types of activities and/or different sequences of activities. In some examples, production circuit assignment data sent by the allocator 212 to a particular work machine 108 may include a ranked list of different production circuits 102 assigned to the particular work machine 108, such that the particular work machine 108 may perform activities associated with different ranked production circuits 102 based on their rank and compatibility. For example, where the first ranked production circuit requires that the work machine be loaded with ore, a work machine that is loaded with waste may switch to an alternate production circuit that is compatible with waste.

A schematic view of a mining site 100 in accordance with the disclosure is shown in FIG. 1. The mining site 100 may include one or more production circuits 102, which relevant to the present disclosure can include one production area 104, one dump area 106, and one or more work machines 108 travelling between the production and dump areas 104 and 106. The production circuits 102 may include a sequence of activities for the mining site 100 and may include conditions for performing the activities within the production circuit 102 as well as a relative ranking of production circuits and/or activities within the productions circuits 102. It should be appreciated that, depending on the material being produced, each production circuit 102 may exclusively include its respective production and dump areas 104 and 106. Alternatively, one production area 104 and/or one dump area 106 may be part of more than one production circuit 102, for example, when material from one production area is used at more than one dump area 106 or, similarly, when the production at a dump area 106 requires material from more than one production area 104.

In general, detailed investigations of the work machine assignments or dispatches of equipment in a mine result from application of a multi-phase optimization via production arcs and return arcs. Production arcs indicate work machine travel segments, in which the work machine travels from a source location, where the work machine is loaded with material, to a destination location, where the work machine dumps the previously loaded material. Return arcs represent work machine travel segments, in which after dumping the material at the destination location, the empty work machine travels from the destination location to a next source location. The source location that follows a destination location need not necessarily be the same source location from which the work machine came from.

Previous solutions that used optimization based on only loaded production arcs may be unreliable to achieve total production or compliance with a production plan. Because the production plan was defined only by the loaded production arcs, the near real time assignment of work machine was sub-optimal, especially with respect to return arcs. In some previous systems, a two-phase approach was employed where a production plan is produced during a first phase, and work machines are assigned in a second phase. In early implementations of production circuits, work machines were only moved to an alternate production circuit where a circuit was under or over-allocated and/or under or over-assigned with work machines. Such approaches may minimize unplanned travel time. However, machines working on a production circuit would sometimes catch up to each other and form a “bunch.” Although bunches naturally clear over time as machines perform various activities, even temporary bunching can result in queuing, loading tool wait time, irregular crusher material flows, or exaggerated peak energy use and accordingly, the allocation systems and techniques described herein provide for resolving such deficiencies.

Accordingly, the systems and methods described herein provide for production circuits 102 that are produced and managed for a mining site to avoid drawbacks, such as those described above. The system at the mining site may perform a three-step operation to produce a production plan, allocate machines to productions circuits based on a ranking within the production plan, and assign machine at or near real-time according to the production plan and allocations. The systems and methods herein provide for production plans that are stable over an extended period of time, irrespective of temporary operational events including short delays that otherwise may create “bunching.” The system (e.g., the planner, allocator, and assigner as described herein) also continuously monitors current, past, and predicted compliance to the production plan and takes action to avoid deviations. These actions may include changing how machines are allocated to production circuits or overriding production circuit capacity. The system also responds to breakdowns of machines, and may reallocate or redistribute machines to meet the production plan. The system may perform reallocations and/or redistributions while taking into consideration the state of charge of machines and the priorities of the production circuits with respect to production targets. In some examples, the system may re-allocate work machines to respond to breakdowns or otherwise optimized compliance with the production plan through the use of an allocator. The systems are also responsible for generating near real-time and/or real-time assignments for machines based on defined machine allocations. The allocations are determined by a controller and/or allocator that determines which machines should be working on each production circuit. Within the determined allocations, real-time or near real-time dispatch may be provided to dispatch machines based on the allocations, where the near real-time assignment does not change the allocation.

The production circuits 102 depicted in FIG. 1 may include a set of production arcs and return arcs that allow for execution of a portion of a production plan. The production circuits may include a production arc and an empty return arc between a loading position 116 and a dump position 124. The production circuits 102 therefore define the series of activities to be performed, such as a travel activity, load activity, dump activity, etc. In some examples, the production circuits 102 may or may not include routes taken by the work machines on the circuit traveling between locations at the mining site 100.

In particular, a controller 112 associated with the mining site may perform the actions described herein by using a planner 202 to produce the production plan, an allocator 212 to allocate work machines to production circuits, and a near real-time assigner 112C to assign machines with at or near real-time management. The planner 202 may generate the production plan to rank one or more production circuits based on a set of priorities and/or goals for the mining site 100. In some particular examples, the allocator 212 may allocate machines to production circuits, for example with production circuit allocations 110 to production circuits in FIG. 1. The allocator 212 may change the production circuit allocations 110 to change production (e.g., to optimize or increase production). The allocator 212 may reallocate machines across defined production circuits to eliminate bunching (e.g., without changes to circuit capacity). The allocator 212 may account for delays, such as from a loader 114 or other machine going on delay for some period of time. In such examples, the allocator 212 may reallocate machines across production circuits to avoid arriving while the machine is on delay. For example, work machines may be reallocated to change destinations or be changed to a different circuit with other machines that are further away and will therefore arrive after the delay is cleared. The allocator 212 may reallocate to avoid queueing, for example if work machines arrive at a loader 114 that already has a full queue may end up waiting, and therefore the allocator may reallocate work machines between production circuits to maintain a smooth flow of material and/or machines to saturated loaders, crushers, charge stations, trolleys, and other such tools (e.g., to provide regular arrivals).

The allocator 212 may manage the production circuits 102 to allow for efficient charging of work machines. For example, a work machine 108 running low on battery power may be moved or transferred to a production circuit where it may charge on a trolley. Accordingly, additional factors may be used to determine assignments of machines to production circuits, including the ranking of production circuits, ranking of activities, work machine factors (such as charging), traffic, and other such factors as described herein.

The allocator 212 may also manage the production circuits and work machines based on conditions of the machines, such as battery status or available energy. Battery electric machines may be reallocated between production circuits to prevent queuing for charge stations or trolley systems and/or to avoid slow travel or charging along the trolley system. Accordingly, the allocator 212 may reallocate machines to smooth peak energy use at charge stations and trolleys. The allocator 212 may also monitor other vehicle operating conditions such as tire temperature and reallocate to prevent and/or avoid tires reaching a threshold temperature.

The allocator 212 may monitor production circuit capacity and may reallocate the machines based on historical, current, or predicted production being under and/or over a specified or planned rate. For instance, a particular circuit may experience a delay (e.g., from a machine delay) and therefore the allocator will identify the change in production rate and reallocate to increase the capacity of other production circuits to maintain a more consistent total production rate, despite the delay on the particular production circuit. The allocator 212 may manage queues of machines at loaders, unloaders, and/or other tools to favor tools with high-capacity or high throughput rates such that the queuing is preferentially employed at destinations with higher capacity or output rates and reduced at destinations with lower capacities or rates.

The allocator 212 may also manage the production circuits based on blends of material at a mining site, such as where different types of material are to be blended at a particular tool. In such examples, the allocator 212 may allocate and reallocate the machines and tools to maintain the blend within a tolerance range or to achieve smaller blending batch sizes.

The allocator 212 may be embodied in one or more computing devices that may be at the mining site 100 and/or remote from the mining site 100 but in communication (over a network) with the various machines and tools of the mining site 100. The allocator 212 may use various methods including heuristics, machine learning, stochastic models, reinforcement learning, simulations, historical analysis, and other such techniques to identify current conditions, predict future conditions, determine probabilistic conditions and likelihoods for various events, and determine reallocations given the constraints of the production plan.

In particular examples where machine learning techniques may be employed by the allocator 212, the machine learning models may be trained to control and/or optimize for various metrics that may be based on the production plan or other metrics. For example, the machine learning models may be trained to output allocations and reallocations of machines across production circuits to control for productivity, compliance with the production plan, smoothing of energy use (e.g., to reduce spikes), vehicle conditions (e.g., tire temperature, energy use, battery damage, etc.), and other such metrics. Accordingly, the allocator 212 may receive information from the various machines (e.g., work machines) and tools (e.g., loaders and crushers) of the mining site 100 such as from sensors of the various machines and tools, communicated over one or more networks at the mining site 100. The sensor data may include information such as location, load, energy storage capacity, temperature sensors, machine performance history, machine metrics, production metrics, and other such data that may be observed from sensor data and/or calculated based on the received data.

In some examples, the allocator 212 may implement reinforcement learning. Reinforcement Learning (RL) is a feedback-based methodology, where the algorithm (e.g., allocator 212) takes in the state and reward as inputs and then gives out the action (allocating a truck for a particular task/production circuit) accordingly to the environment (mine site with trucks, loaders, etc.). The allocator 212 continuously learns from the feedback to give out better actions towards fulfilling the business goals/production targets. In a RL example, the environment (e.g., mine) may provide state and reward information. The allocator 212 may include a deep learning-based algorithm, for example a functional approximator based algorithm, which can learn based on a given set of input-output pairs. The allocator 212 takes in the state and reward information as inputs and provides an output defining an action to the environment. The state information may include information such as a truck state including truck position, battery SoC, payload, etc. The state information may also include other destination-related details such as loading zone queues, delays, and other such information. The reward may include or define the impact of an action in the environment. This will enable the allocator 212 to learn valid state-action pairs. For instance, a positive reward for the allocator 212 giving out actions which ensures blending requirement, a negative reward for the allocator 212 giving out actions which cause queuing in the destination. The various actions output by the controller may include allocating trucks to a production circuit, reallocation of circuits among the production circuits in case of unforeseen incidents such as a truck breaking down, short term assignments for trucks such as detour to another loading zone, charging station, etc. Initially, the allocator 212 may be trained on historical data (input-output pairs). The allocator 212 may then continuously learn from the current environment to provide improved action outputs.

The RL example of the allocator 212 may enable reallocation of work machines in situations of unforeseen events and delays. For example, if a work machine breaks down in a specific production circuit, then work machines from other production circuits may be reallocated to minimize the negative impact on production targets/business objectives.

In some examples, the RL implemented on the allocator 212 may be scalable to larger environments (e.g., larger mine sites with a greater number of work machines, etc.) and can handle large amounts of data with continuous values (such as Battery SOC values, payloads of various work machines). Further, the feedback mechanism in RL provides for continual learning, e.g., the algorithm will improve upon the actions given out dynamically to fulfil business objectives/production goals.

In the description that follows, exemplary embodiment of autonomous work machines is used for sake of description, as this represents an application that can benefit from the advantages of the disclosed system and method, but it should be appreciated that the systems and methods described herein are applicable to any dispatch application used to control assets at a mine site, quarry, construction site, or other such worksite, whether those assets are operated manually by humans or autonomously. It should be appreciated, however, that even manually operated assets can benefit from automated dispatch systems and methods as described herein.

In the mining site 100, each production circuit 102 may include a dedicated allocator 212 that can monitor, control and/or relay information to or from assets such as a plurality of work machines, which are denoted as 108, and other machines that may be operating within each production circuit 102. A central controller (e.g., a planner 202) may communicate with the allocator 212 associated with production circuits 102 to relay and exchange high-level information that pertains to the mining site 100 as a whole.

Each production circuit 102 can include a destination, which may be operated by one or more loaders 114. During operation, one or more work machines 108 may arrive at the production area 104 for loading, for example at a loading position 116. A production queue 118 may stack the work machines 108. A loaded work machine 120 may travel a production arc 122 between the loading position 116 and a dump position 124 at the dump area 106. Loaded work machines may similarly be stacked at a dump queue 126 while waiting to assume the dump position 124. Emptied work machines 128 may travel a non-production return arc 130 between the dump position 124 and the production queue 118 or the loading position 116 before repeating the production arc 122. This process, or a variant thereof, may be carried out in each of the production circuits 102 during operation.

The rate of material transfer from the production area 104 to the dump area 106 can be quantified and compared to a target production rate defined within a production plan for the production circuit 102. This production rate, from an asset engagement perspective, occupies a plurality of work machines 108 that are assigned to, or engaged in, the production circuit 102 during operation. As can be appreciated, in any given circuit, longer wait times of work machines in queues 118 and 126 can slow down the scheduled deliveries thereby reducing the overall production rate for that particular circuit. Moreover, the production plan at each particular circuit, even if optimized at the beginning of the production cycle, requires re-optimization due to longer wait times in queues 118 and 126. The production plan is durable over an extended period of time, accordingly, as conditions change and/or vary the allocator 212 may account for such variations using the stochastic models, heuristics, and other models described above. To accomplish this, in part, the number of work machine assignments to a circuit may be changed (increased or decreased) based on the production plan. In general, the production plan defines the amount of material moved from one or more locations in the mine to one or more other locations in the mine, which material movement can be expressed as a total tonnage of material over a period of time that is moved, or alternatively a rate of transfer of material in tons per hour, and the like. The present description provides a solution to address low productivity concerns by reallocation of resources over a mining site 100, as opposed to only a particular circuit, which can be carried out automatically and in real time or “on-the-fly” in a few different respects, which will be discussed herein.

In some examples, the production circuits described herein may include a single task such as moving material by loading material into a work machine and dumping the material at a destination. In some examples, the production circuit may include multiple tasks such as moving material from a first location to a second destination and then subsequently moving material from a third destination to a fourth destination. In such examples, the production circuit may be completed one or more times, such as an iterative process. The production circuits 102 may be single task or multiple task in instances where there is an opportunity to move materials in opposite directions at a mining site 100. For example, a mining site 100 might use work machines to move ore in a first direction and waste in a second direction opposite the first direction. In this manner, the work machines may be used to increase productivity by allowing the work machines to spend more time (as a function of a proportion of the total time for the production circuit) loaded compared to traveling empty.

The planner 202 may manage the production circuits 102 to allocate available energy at the mining site 100 to charge stations and trolleys. The available energy may include peak and average limits for available energy. The allocator 212 may manage to these limits at the mining site 100 based at least in part on limits that may be set manually (e.g., by a mine controller) and/or dynamically by a site energy management system.

The allocator 212 may receive a production plan (e.g., a set of production circuits 102). The allocator 212 may include an assignment component that may manage energy use rates for particular electrical trolley stations by production circuits 102. In some examples, the trolley may include designs employing trolley poles, bow collectors, underbody collectors, and other forms of ‘live’ electricity transfer. For example, the trolley system may alternatively include a ground-level power supply, wherein the one or more contact lines may include conductive rails or tracks; and the charging apparatus may include an underbody collector configured to interact therewith. And in other examples, the trolley system may include non-contact conductors, such as those facilitating in-road inductive charging. Indeed, the contact lines may embody any form of ‘live’ electricity supply and the associated charging apparatus may embody any form of ‘live’ electricity receipt, depending on specific applicational requirements. The allocator 212 may produce and/or receive the production plan to include and define production plan data such as material flow rates (e.g., target rates at which material is expected to flow from loaders to dump locations), production circuits (e.g., the number of circuits, routing of production circuits, etc.), production circuit capacity (e.g., the number of work machines allocated to each production circuit), distribution of battery electric work machines and non-battery work machines to production circuits, production circuit energy flow rates (e.g., the target rates for energy to flow through trolleys to individual production circuits and work machines). The energy available may be allocated based on information from the planner 202 such as allocation by the planner 202 based on a ranking and/or preference order, with priority given to production circuits 102 assigned higher priority. In some examples, some production circuits 102 with low priority may not receive energy from the system as the planner 202 may instead allocate the energy to production circuits 102 having higher assigned priorities. The priority for the production circuits 102 may be assigned by the planner 202 and/or other systems based at least in part on the tasks performed by the production circuits. In some examples, the tasks may be ranked and/or given priority ranking relative to one another.

The planner 202 may distribute energy across the production circuits 102 based at least in part on a strategy that may be defined to distribute battery electric machines and non-battery electric machines. The distribution may be based on maximizing productivity, reducing and/or minimizing battery damage, smoothing peak energy use, and other such factors.

The controller 112 may provide assignments of work machines to production circuits 102 and define production circuits 102 around tasks with at or near real-time assignments. The near real-time assigner 112C may communicate at or near real-time with the work machines, such as the work machines of the mining site 100, by sending messages over a network at the mining site 100.

In some examples, the allocator 212 may enable work machines to be assigned to production circuits 102 such that tasks or activities may be repeated one or more times within the production circuit. After a machine is assigned to a production circuit 102, the controller 112 may reliably predict future activities by the work machines over a pre-defined time period. The near real-time assigner 112C may, in some instances, also perform assignments based on the defined allocations at near real-time. The allocator 212 may work in a limited timeframe (e.g., over a window of limited minutes such as five to ten minutes) to feed a near real-time assigner 112C that is capable of adapting and working in or near real-time to adjust assignments. The allocator 212 may also assign work machines to production circuits 102 and use the assignments to production circuits to distribute work machines with or without real-time or near real-time reassignment of work machines such as by the near real-time assigner 112C.

The allocator 212 may use one or more methods and/or algorithms to dynamically allocate work machines to production circuits 102 in order to avoid bunching, queuing, and other such problems frequently encountered at mining sites. The algorithms and methods implemented by the allocator 212 may include a combination of heuristics, simulation, stochastic models, reinforcement learning, or other machine learning and/or heuristic-based approaches to re-allocate work machines to production circuits 102 such that productivity is not adversely impacted. Machine learning may be used by the allocator 212 to learn and detect specific issues such as bunching, delays, blend tolerance, saturated loading tools crushers and equipment, available energy for smooth peak energy use, tire temperature, production circuit capacity, over-assigned/under assigned circuits and destinations, and opportunistic charging to divert work machines to charge on production circuits with a trolley.

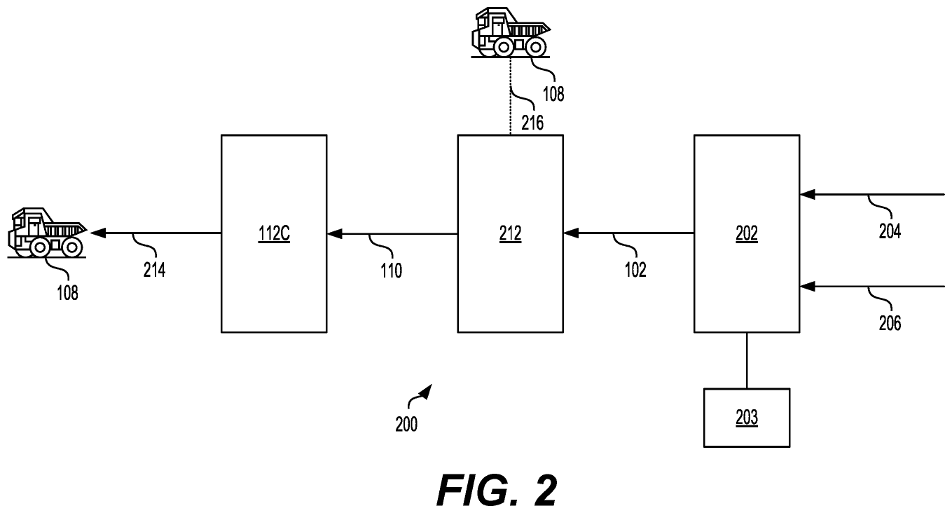

FIG. 2 is a block diagram of a dispatch system 200 in accordance with a first embodiment of the disclosure. The dispatch system 200 includes a planner 202, which may be operating within or in conjunction with the planner 202 and/or the allocator 212. The planner 202, which may be implemented in the form of computer executable instructions in non-transitory computer media, includes algorithms that use various computational or algorithmic methods to process a desired production plan. The desired production plan may be provided by a user and input into the system. For example, the planner 202 may include computer hardware and/or software that includes memory devices, user input and output instrumentalities, a processor, database, wired and/or wireless communication devices and other structures that are configured to receive, process and send information to/from the planner 202.

In the illustrated embodiment, the planner 202 is configured to receive as an input a production plan 204. The production plan 204 may be manually or automatically input into the planner 202 and can include information on the desired or target production for the mine on a shift and/or daily basis, production goals for the mid- or long-term operation, production types and timing of product delivery for the mine, scheduling, and other information relating directly to the desired type, amount and timing of mine output or production. This information may be input by a user by defining various system parameters included in a software application that is operating within the planner 202, or may alternatively be provided automatically, for example, by processing customer orders for material that are submitted by customers, for example, over an internet-based ordering system. Regardless of the type or method of input of this information, the production plan 204 is provided to the planner 202 and serves as a basis for all or most subsequent operations in the dispatch system 200.

In addition to the production plan 204, the planner 202 further receives as an input the mine state information 206, which can be provided manually by a mine operator or can be extracted automatically by the planner 202. The mine state information 206 includes information indicative of the number and operational state of work machines that are available for work at any one time, the number, capacity and operational state of loading tools, processors, materials and mining blocks that are active, the type of material blocks that are active, the location of material blocks, and the like. In general, the mine state information 206 provides information indicative of all useable resources available at any given time at the mine for production, transportation and processing of one or more products produced or placed at the mine.

Based at least on the production plan 204 and mine state information 206, the planner 202 uses various methods to calculate or estimate the production circuits 102 that are available or required to achieve or optimally approximate the production plan 204 based on the mine state information 206. These calculations may be carried out using various methods. In the illustrated embodiment, the planner 202 uses artificial intelligence (AI) methods of assigning the number of production circuits 102 that suffice to achieve a production goal. In the illustrated embodiment, an AI engine 203 is shown in conjunction with the planner 202. During operation, a desired production in tons/hour can be calculated based on a production goal for a finite time period (e.g., 24 hrs. of mine operation) based on the payload carrying capacity of the work machines (in tons/arc), the number of work machines available for transfer, the transfer and return times, the distance between the source location or production site to the destination location or dump site, and the production rate of the loaders.

As can be appreciated, optimization of mine resource utilization can vary based on the various work machine assignments that are made to achieve a target production rate via the production circuits 102. This optimization task is carried out by the allocator 212, which receives the production circuits 102 from the planner 202. The allocator 212 may be implemented as part of a three-step process that includes planning, allocating (e.g., performing the actions described with the allocator 212), and assigning or dispatching the work machines. The allocator 212 determines or receives the production plan (e.g., from the planner 202), allocates resources according to the production plan, and dispatches the resources (e.g., using an assigner). To accomplish this, in one example, the allocator 212 allocates to production circuit allocations 110, and commands work machines 108 to production circuit allocations 110 to the near real-time assigner 112C or sends a set of ranked production circuits 216 to work machines 108. The commands 214 are an output of the near real-time assigner 112C. The commands 214 are specific commands for each work machine 108 in each production circuit 102 to perform a specific task. Each of the work machines 108 may be operated by a human operator, or may be self-driven. In either case, the commands or assignments are received autonomously by the work machine 108. While the work machines perform the various tasks, information is provided back to the allocator 212 that indicates task progress, work machine position, diagnostics and other information such that subsequent allocations of the work machine may be further optimized, for example to avoid bunching, queuing, peak energy use, excessive tire heat, and other such examples.

The allocator 212, may be operating within the controller 112 (FIG. 1), which can disseminate information between the planner 202 and the allocator 212 for the production circuits 102, which in turn relay information to/from the various assets including the work machines 108. The allocator 212 may determine and/or receive the production plan, allocate resources, and assign work machines to production circuits. The allocator 212, like the planner 202, may be implemented in the form of computer executable instructions in non-transitory computer media includes an algorithm that use various computational or algorithmic methods to allocate specific machines to the ranked set of production circuits received from the planner 202. As such, the allocator and/or assigner may be implemented in the form of computer hardware and/or software that includes memory devices, user input and output instrumentalities, a processor, database, wired and/or wireless communication devices and other structures that are configured to receive, process and send information to/from the allocator 212 and various other external systems including systems operating and/or controlling operation of the work machines 108. The near real-time assigner 112C may run on an on-board processor of a work machine 108 where work machines (e.g., trucks) are assigned to a ranked set of production circuits.

During operation, the allocator 212 operates using various methods including statistical methods and AI models to minimize the time spent by work machines 108 executing non-production return arcs 130 (FIG. 1). To achieve this result, it is often the case that a work machine may not return to the same loading location from which it was loaded on production arc that was just completed, but rather be re-routed to a different production location, possibly within a different circuit, that is either closer, has a higher priority, or is expected to be ready to load sooner than other loading locations. The allocator 212 of FIG. 1 may dynamically allocate machines to production circuits so they may be dispatched by the near real-time assigner 112c within the context of those allocations. The assigner, e.g., a controller that performs the dispatching and/or assignment once machines are allocated, does not determine the allocation, as that is handled by the allocator 212 based on the production plan from the planner 202. To determine the optimal return arc, the planner may determine many return arcs for the same work machine before selecting the return arc that is most optimal in terms of distance and time for the particular work machine. Some exemplary operating conditions are shown in the block diagrams of various mining sites that follow.

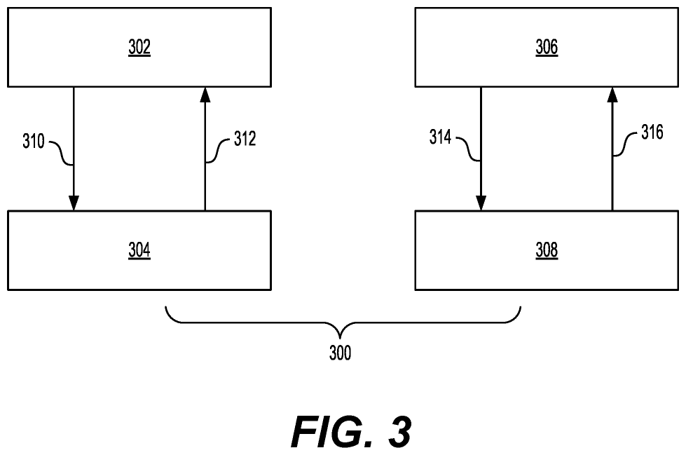

One block diagram for a system 300 is shown in FIG. 3. In this system, a first production circuit includes a first loading tool 302 and a first processor 304. A neighboring production circuit includes a second loading tool 306 and a second processor 308. Due to the physical distance between the two production circuits, the assigner may work together with an allocator and may elect to cycle the work machines assigned to each circuit between the same two locations, and to optimize the operation based on the travel time such that queues 118 and 126 (FIG. 1) are minimized at the production tools and processing dump sites. Accordingly, when the system 300 operates, loaded or production arcs 310 are assigned between the first loading tool 302 and first processor 304, and empty or return arcs 312 are assigned between the first processor 304 and the first loading tool 302. Similarly, production arcs 314 and corresponding return arcs 316 are cycled, assigned, or allocated between the second loading tool 306 and the second processor 308.

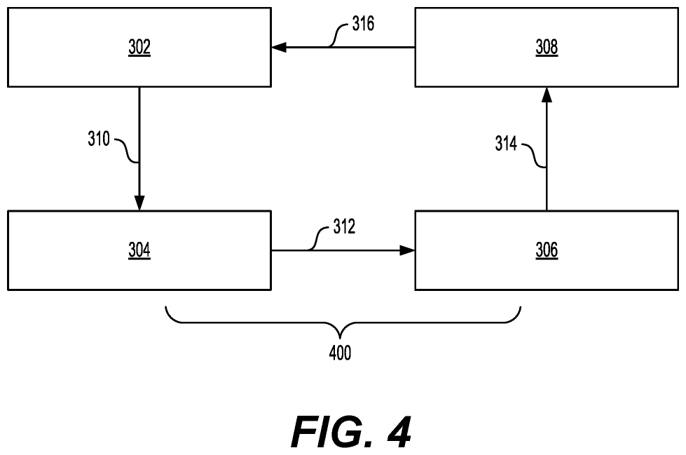

Another block diagram for a system 400 is shown in FIG. 4. In this diagram, for the sake of description, the same loading tools and processors are shown as in the system 300 shown in FIG. 3, but their locations have changed to account for a mine site in which the physical location of these areas, or the travel time between them has changed. As can be seen, these two circuits may operate in a combined fashion in which, as before, production arcs 310 from the first loading tool 302 are routed to the first processor 304, and production arcs 314 from the second loading tool 306 are routed to the second processor 308, but the corresponding return arcs 312 and 316 are switched between the two circuits, for example, when the first loading tool 302 is closer to the second processor 308, or the second loading tool 306 is closer to the first processor 304. In this arrangement, the return arc 312 from the first processor 304 is routed to the second loading tool 306, rather than the first loading tool 302. Likewise, the corresponding return arc 316 from the second processor 308 is routed to the first loading tool 302, instead of the second loading tool 306. In a way, the work machines in the system 400 are constantly circling both loading tools and both processors in alternating sequence.

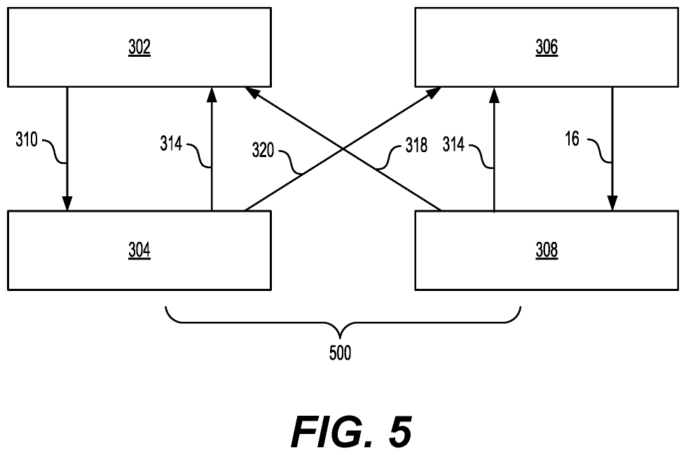

An additional block diagram for a system 500 is shown in FIG. 5. In this diagram, for the sake of description, the same loading tools and processors are shown as in the systems 300 and 400, shown in FIGS. 3 and 4, but their locations have changed to account for a mine site in which the physical location of these areas, or the travel time between them has changed. In this condition, a distance between the first loading tool and processor in the first circuit may be different than the corresponding distance between the second loading tool and processor in the second circuit. As can be seen, these two circuits may operate in a combined fashion in which, as before, production arcs 310 from the first loading tool 302 are routed to the first processor 304, and production arcs 314 from the second loading tool 306 are routed to the second processor 308. Return arcs can take alternative routes such that a return arc 312 initiated at the first processor 304 may more optimally be routed back to the first loading tool 302 or to the second loading tool 306 via alternative return arc 320. Similarly, a return arc 312 initiated at the second processor 308 may be routed back to the second loading tool 306 or may alternatively be routed to the first loading tool 302 via alternative return arc 318.

As can be appreciated, whether the in-circuit or alternative return arc is selected may depend on the allocator and/or planner's estimation of where the assets might be best utilized in real time, with reassignments of work machines between circuits being used to balance the ability of each circuit to achieve the best production rate. For example, a higher rate at the first circuit may cause more than half the work machines in that circuit to be in a loaded production arc while covering a large distance. This condition may lead to excess empty work machines, some of which may be, at least temporarily, reassigned to the second circuit via alternative return arc 320.

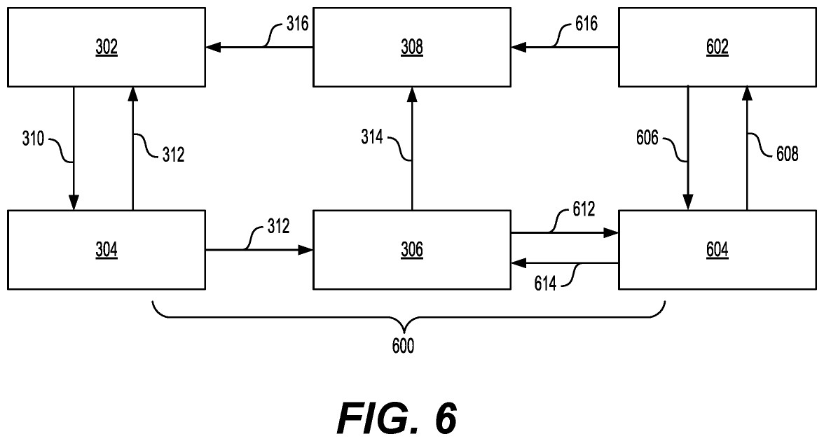

A more complex arrangement for a system 600, which further includes a third circuit having a third loading tool 602 and a third processor 604 is shown in FIG. 6. In this embodiment, it can be seen that the alternative return arc functionality described in the previous embodiments of systems 300, 400, and 500 can be combined and used simultaneously. Without describing the various arcs previously described, which are denoted by the same reference numerals previously used, and are routed as previously described, it can be seen that a third production arc 606 and corresponding third return arc 608 exists between the third loading tool 602 and third processor 604. However, due to proximity, time, different production goals etc., additional production arcs 614 exist from the second loading tool 306 to the third processor 604 and corresponding return arcs 612 are routed between the third processor 604 and second loading tool 306. Such situation may occur when a larger density of work machines is desired around the third processor 604, for example, if it is located further away from the other tools and processors. To balance the distribution of work machines at the mine, and avoid excessive bunching, which can lead to traffic congestion, a balancing routing configuration revolves around sending extra return arcs to the first loading tool 302 via 312 and 316.

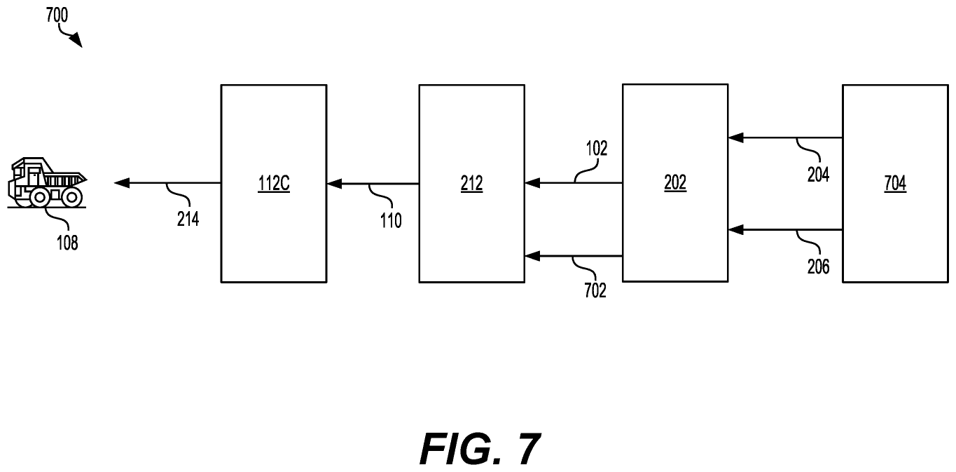

FIG. 7 is a block diagram of a system 700 in accordance with a second embodiment of the disclosure. The system 700 builds onto the dispatch system 200 (FIG. 2) that was previously described, but also includes additional functionality to address the quickly mounting complexity that is introduced in large mining operations having two, three or more circuits. In this system, features and systems that are the same or similar as corresponding features and systems previously described relative to FIG. 2 are denoted by the same reference numerals as previously used for ease of understanding and simplicity.

As can be appreciated, large mining operations that include two, three or more circuits can quickly develop multiple possible production and return arcs that can be used to reassign work machines between different circuits either temporarily or on a rolling basis. Such operation may take the work machine away from housekeeping services, for example, machine shops in case of a failure, fuel depos for refueling, inspection stations and the like. To oversee the multitude of different operating positions of assets, while still tracking assets such as work machines that go “offline” for service, refueling, inspection and the like, the system can reassign work machines, for example, to run a circuit that is close to a service station, fuel depot, and the like to minimize the time the work machine is taken out of service.

To aid in this additional layer of complexity, the system 700 may further include a virtual controller service 704. The virtual controller service 704 may be implemented in conjunction with the production planner, allocator, and assigner to monitor overall operations and, when appropriate, intervene to reallocate system resources for system resource optimization. This can be accomplished, in part, by monitoring target productivity versus actual productivity. For example, the production planner may provide information consistent with the expected or predicted travel and service times for work machines executing the production circuits 102 and balancing arcs 702, which the production planner uses during its estimations or calculations. The virtual controller service 704 may further receive the actual travel and service times corresponding to the same work machines to determine whether any discrepancies exist that might affect overall compliance to a defined short-term plan (such as the production plan 204 referred to herein, and in some instances the production plan 204 may include a short-term plan, daily plan, shift plan, or other such plan) or other business objectives. Various parameters can affect such discrepancies, including weather impacting traction, visibility and the like, which may increase travel times at the mine site, obstructions such as avalanches, landslides, or degraded road conditions, and the like. When discrepancies are determined to exist, immediate action can be taken by providing notification, other recommendations, or autonomous action to modify the short-term plan or modify the worksite configuration. Adjustments can include reassignments of work machines including loading tools and auxiliary machines, changing the priority of tasks, modifying tasks, opening and closing destinations (e.g., loading or dump areas), or requesting additional power (e.g., changing available energy limits).

It is contemplated that the function of the virtual controller service 704 will augment the operation of the planner, allocator, and assigner through the application of machine learning and other AI techniques. The virtual controller service 704 will monitor the global state of the system and intervene as appropriate to improve overall productivity and compliance with the production plan 204. The virtual controller service 704 further operates to monitor deviations of actual travel times and service times for work machines with active scheduled assignments. When actual travel or service times start to deviate from expected times to the extent that the short-term plan is no longer achievable, action is taken immediately to adjust the short-term plan or modify the worksite configuration to improve business outcomes.

The virtual controller may further communicate with other assets at the mine site. For example, it can monitor crushers and/or coarse (“COS”) for potential conditions in which incoming material is insufficient to occupy a rock crusher continuously, i.e., the rate of incoming material is below the throughput of the crusher. When a potential empty belt is predicted, the virtual controller may take immediate action to avoid empty belts, for example, by increasing the priority of the related task, opening or closing destinations (e.g., loading or dumping areas), or requesting additional power (e.g., modifying available energy limits).

In the embodiment for the dispatch system 200, shown in FIG. 2, and the system 700 shown in FIG. 7, it is contemplated that the planner 202 may work on predetermined time windows over which the available resources (indicated via mine state information 206) are assumed to remain constant. The planner 202 performs the complex optimizations required to determine the optimal paths for work machines to follow within the constraints of predicted travel and service times. The allocator 212 and near-real time assigner work much more rapidly, for example, on 0-5 second periods, to respond immediately to work machines that need new assignments. Where actual travel and service times are close to predicted times, the assignments made by the assigner will suffice to implement the production plan 204 as calculated by the planner 202.

In the embodiment for the system 700 shown in FIG. 7, the virtual controller service 704 operates to respond by notifications, other recommendations, or through autonomous actions to resolve conditions that may prevent the dispatch system (plan, allocate, and assign) from achieving the active short-term plan (e.g., tasks). Such actions may include modifying the active short-term plan (e.g., tasks), opening or closing destinations, requesting additional power (for charging), or relocating equipment (loading tools, dozers, etc.). The virtual controller service may use various methods including simulation, machine learning or reinforcement learning to choose an optimal configuration from a large number of alternative work site configurations to better achieve the active production plan or other defined business objectives.

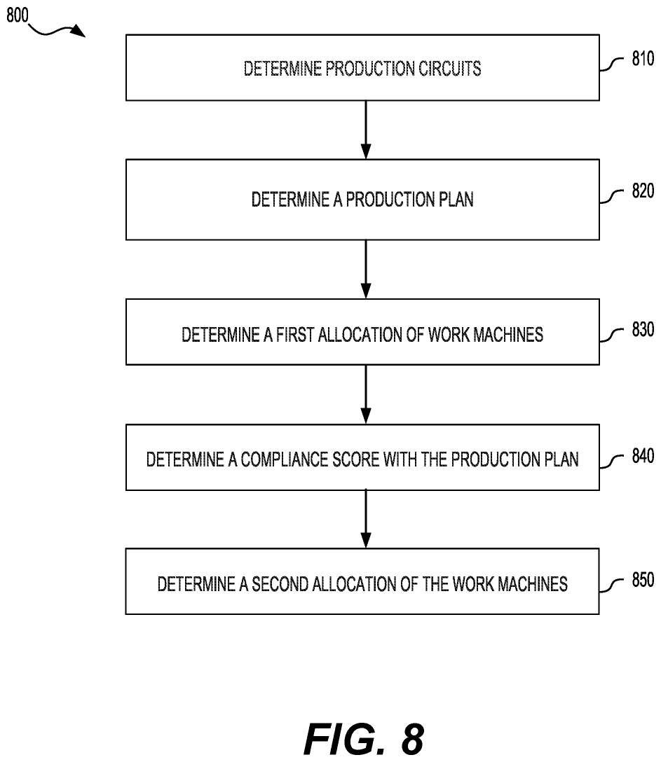

FIG. 8 illustrates a flow diagram of a method according to the present technology. For simplicity of explanation, the method is depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

Any of a variety of other process implementations which would occur to one of ordinary skill in the art, including but not limited to variations or modifications to the process implementations described herein, are also considered to be within the scope of this disclosure.

FIG. 8 is a flowchart of a method 800 of allocating and reallocating work machines in a mining site in accordance with the disclosure. The method 800 may include determining one or more production circuits for a mining site at step 810. The production circuits may include a set of production arcs and return arcs that allow for execution of a portion of a production plan at the mining site. The production circuits may include a production arc and a return arc between a loading position and a dump position. The production circuits therefore define the routes taken by the work machines on the circuit traveling between locations at the mining site.

In some examples, the production circuits described herein may include a single task such as moving material by loading material into a work machine and dumping the material at a destination. In some examples, the production circuit may include multiple tasks such as moving material from a first location to a second destination and then subsequently moving material from a third destination to a fourth destination. In such examples, the production circuit may be completed iteratively. The production circuits may be single task or multiple task in instances where there is an opportunity to move materials in opposite directions at a mining site. For example, a mining site might use work machines to move ore in a first direction and waste in a second direction opposite the first direction. In this manner, the work machines may be used to increase productivity by allowing the work machines to spend more time (as a function of a proportion of the total time for the production circuit (loaded compared to traveling empty.

At step 820, the controller may determine a production plan. The production plan may include a ranked ordering of production circuits within the mining site. The controller may produce a production plan that is stable over an extended period of time, irrespective of temporary operational events including short delays that otherwise may create “bunching.” The controller also continuously monitors current, past, and predicted compliance to the production plan and takes action to avoid deviations. These actions may include changing how machines are allocated to production circuits or overriding production circuit capacity. The systems are also responsible for generating near real-time and/or real-time assignments for machines given a ranked set of production circuits according to the production plan.

In particular, the controller may perform the actions described herein to produce the production plan, allocate to production circuits, and assign machines with at or near real-time management. The controller may generate the production plan to rank one or more production circuits based on a set of priorities and/or goals for the mining site. In some particular examples, the controller may allocate machines to production circuits to change production (e.g., to optimize or increase production). The controller may reallocate machines across defined production circuits to eliminate bunching (e.g., without changes to circuit capacity). The controller may account for delays, such as from a loader or other machine going on delay for some period of time. In such examples, the controller may reallocate machines across production circuits to avoid arriving while the machine is on delay. For example, work machines may be reallocated to change destinations or be changed to a different circuit with other machines that are further away and will therefore arrive after the delay is cleared. The controller may reallocate to avoid queueing, for example if work machines arrive at a loader that already has a full queue may end up waiting, and therefore the controller may reallocate work machines between production circuits to maintain a smooth flow of material and/or machines to saturated loaders or other such tools (e.g., to provide regular arrivals).

The controller may generate and manage the production plan (e.g., a set of production circuits). The controller may include an assignment component that may define energy use rates for particular electrical trolley stations by production circuits. The controller may product the production plan to include and define production plan data such as material flow rates (e.g., target rates at which material is expected to flow from loaders to dump locations), production circuits (e.g., the number of circuits, routing of production circuits, etc.), production circuit capacity (e.g., the number of work machines allocated to each production circuit), distribution of battery electric work machines and non-battery work machines to production circuits, production circuit energy flow rates (e.g., the target rates for energy to flow through trolleys to individual production circuits and work machines). The energy available may be allocated by the controller based on a ranking and/or preference order, with priority given to production circuits assigned higher priority. In some examples, some production circuits with low priority assigned may not receive energy from the system as the controller may instead allocate the energy to production circuits having higher assigned priorities. The priority for the production circuits may be assigned by the controller and/or other systems based at least in part on the tasks performed by the production circuits. In some examples, the tasks may be ranked and/or given priority ranking relative to one another.

The controller may distribute energy across the production circuits 102 based at least in part on a strategy that may be defined to distribute battery electric machines and non-battery electric machines. The distribution may be based on maximizing productivity, reducing and/or minimizing battery damage, smooth peak energy use, and other such factors.

At step 830, the controller may determine a first allocation of work machines to the production circuits based at least in part on the production plan. The controller may manage the production circuits to allocate available energy at the mining site. The available energy may include peak and average limits for available energy. The controller may manage limits at the mining site based at least in part on limits that may be set manually (e.g., by an office) and/or dynamically by a site energy management system, such as a sub-component of the controller.

The controller may provide assignments of work machines to production circuits and define production circuits around tasks with at or near real-time assignments. The controller may communicate at or near real-time with the work machines, such as the work machines of the mining site, by sending messages over a network at the mining site.

In some examples, the controller may enable work machines to be assigned to production circuits such that tasks or activities may be repeated one or more times within the production circuit. After a machine is assigned to a production circuit, the controller may reliably predict future activities by the work machines over a pre-defined time period. The controller may allocate assignments to production circuits at near real-time in some examples. The controller may also allocate assignments to production circuits and adjust assignments through near real-time assignments. The controller may also assign work machines to production circuits and use the assignments to production circuits to distribute work machines with or without real-time or near real-time reassignment of work machines.

The controller may use one or more methods and/or algorithms to dynamically allocate work machines to production circuits in order to avoid bunching, queuing, and other such problems frequently encountered at mining sites. The algorithms and methods implemented by the controller may include a combination of heuristics, simulation, reinforcement learning, or other machine learning and/or heuristic-based approaches to re-allocate work machines to production circuits such that productivity is not adversely impacted. Machine learning may be used by the controller to learn and detect specific issues such as bunching, delays, blend tolerance, saturated loading tools crushers and equipment, available energy for smooth peak energy use, tire temperature, production circuit capacity, over-assigned/under assigned circuits and destinations (e.g., tools), and opportunistic charging to divert work machines to charge on production circuits with a trolley.

At step 840, the controller may determine a compliance score describing compliance with the production plan. The controller may continuously monitor current, past, and predicted compliance to the production plan and takes action to avoid deviations. These actions may include changing how machines are allocated to production circuits or overriding production circuit capacity. The systems are also responsible for generating near real-time and/or real-time assignments for machines given a ranked set of production circuits according to the production plan.

The controller may allocate and re-allocate work machines based on the compliance, such as described with respect to step 850 below. The controller may determine compliance using one or more machine learning algorithms, machine learning, and other AI techniques. The controller will monitor the global state of the system and intervene as appropriate to improve overall productivity and compliance with the production plan. The actions to be performed by the controller may include monitoring all assignments to optimize arrival times and minimize queue times, which can include constant monitoring of actual travel times and service times as compared to predicted travel times and service times. Where actual times start to deviate from predicted times, the virtual controller may with the planner, allocator, and assigner to perform the various operations of each, such as adjusting the short-term plan (e.g., tasks), recommending adjustments to the plan, redeploying or recommending redeployment of assets to achieve the plan, and other such actions.

The controller may further communicate with other assets at the mine site. For example, it can monitor crushers and/or coarse (“COS”) for potential conditions in which incoming material is insufficient to occupy a rock crusher continuously, i.e., the rate of incoming material is below the throughput of the crusher. When a potential empty belt is predicted, the virtual controller may take immediate action to avoid empty belts, for example, by increasing the priority of the related task, opening or closing destinations (e.g., loading or dumping areas), or requesting additional power (e.g., modifying available energy limits).

At step 850, the controller may determine a second allocation of the work machines. The second allocation of the work machines may include a reallocation of the work machines based on the compliance score and/or production plan. The controller may reallocate machines across defined production circuits to eliminate bunching (e.g., without changes to circuit capacity). The controller may account for delays, such as from a loader or other machine going on delay for some period of time. In such examples, the controller may reallocate machines across production circuits to avoid arriving while the machine is on delay. For example, work machines may be reallocated to change destinations or be changed to a different circuit with other machines that are further away and will therefore arrive after the delay is cleared. The controller may reallocate to avoid queueing, for example if work machines arrive at a loader that already has a full queue may end up waiting, and therefore the controller may reallocate work machines between production circuits to maintain a smooth flow of material and/or machines to saturated loaders or other such tools (e.g., to provide regular arrivals).

The allocator may also manage the production circuits and work machines based on conditions of the machines, such as battery status or available energy. Battery electric machines may be reallocated between production circuits to prevent queuing for charge stations or trolley systems and/or to avoid slow travel or charging along the trolley system. Accordingly, the allocator may reallocate machines to smooth peak energy use at charge stations and trolleys. The allocator may also monitor other vehicle operating conditions such as tire temperature and reallocate to prevent and/or avoid tires reaching a threshold temperature.

The allocator may monitor production circuit capacity and may reallocate the machines based on historical, current, or predicted production being under and/or over a specified or planned rate. For instance, a particular circuit may experience a delay (e.g., from a machine delay) and therefore the allocator will identify the change in production rate and reallocate to increase the capacity of other production circuits to maintain a more consistent total production rate, despite the delay on the particular production circuit. The allocator may manage queues of machines at loaders, unloaders, and/or other tools to favor tools with high-capacity or high throughput rates such that the queuing is preferentially employed at destinations or tools with higher capacity or output rates and reduce at destinations with lower capacities or rates.

The allocator may also manage the production circuits based on blends of material at a mining site, such as where different types of material are to be blended at a particular tool. In such examples, the allocator may allocate and reallocate the machines and tools to maintain the blend within a tolerance range.

The allocator may additionally cause the work machines to dispatch according to the second allocation. The allocator may, during the reallocation according to the second allocation, maintain production rates, such as material flow through the various production circuits, for example by balancing machines moved between circuits. For instance, if a machine is moved from a first circuit, then a different machine may be added to the first circuit to account for a reduction in material flow rate.

All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated. All methods described herein can be performed in any suitable order unless otherwise indicated herein or otherwise clearly contradicted by context.

### INDUSTRIAL APPLICABILITY

The present disclosure may find industrial applicability toward mining sites and specifically toward work machines and their associated systems such as charging networks, and may be particularly useful toward fleets of zero-emission work machines, diesel electric work machines, fuel cell machines, and other such machines that may be charged by a trolley network. The systems and methods described herein may provide energy efficiency as well as reduced emissions.

For example, the present disclosure may be applied to a mining site with work machines that may include a large mining truck, excavator, backhoe, bulldozer, grader, trencher, tractor, front loader, and yet other possibilities. The work machines may specifically be a zero-emission vehicle, such as one being powered exclusively by electric batteries, diesel electric machines, or hydrogen fuel cells (when disconnected from external power sources). The work machine may operate independently, e.g., may self-manage its power usage of the trolley network; or the work machine may be centrally managed, e.g., by the controller. The work machines may be managed for production efficiency and therefore to reduce wasted energy as well as to prolong lifespan of work machines and their components.

Moreover, the present disclosure may be applied to a fleet of zero-emission work machines. For example, a plurality of work machines may be employed collectively on an open-pit mine, underground mine, a road construction work zone, a farm or ranch, and yet other possible work sites. The fleet may include a plurality of work machines being supplied electric power through the trolley network. Moreover, the present disclosure may be applied to a fleet which includes zero-emission vehicles, diesel-electric vehicles, and other vehicles capable of being supplied electric power through a trolley network. Advantageously, an existing management system for a fleet of diesel and diesel electric vehicles may be modified with the systems and methods disclosed herein to include zero-emission vehicles such as battery electric machines and fuel cell machines.

Finally, the present disclosure may be applied to a trolley network, such as one employing overhead wires, ground-level power supplies, non-contact conductors or in-road inductive charging, railway electrification technologies, and yet other possible forms of live-electricity transfer. The trolley network may be powered through independent power generation mechanisms, and/or may transfer electric power from external sources.

Advantageously, the present disclosure may enable an optimized power usage of the trolley network by a plurality of work machines; and may improve a productivity, an energy efficiency, and a longevity of each machine, one or more work machines, and/or the fleet as a whole.

The present disclosure may extend each of the above advantages toward a plurality of work machines or an entire fleet of work machines. By following the various methods disclosed herein, the fleet and trolley system can optimize for a productivity, an efficiency, and/or a longevity of a single work machine, of one or more work machines, or of the entire fleet as a whole. Individual work machines within the fleet may be prioritized, such as by receiving greater allocations of power to their batteries or to their tractive device.

Finally, the present disclosure may improve the logistical operations of the fleet and the network. By managing the actions and production circuit allocation of each work machine, the present disclosure may reduce ‘congestion’ along the route of the network, may better align each machine with its assigned tasks, may guarantee that each machine is sufficiently charged for its assigned tasks, may improve collaboration between machines having shared tasks, may stabilize the power output or saturation of the trolley network, and yet other possibilities.

1. A system for allocating work machines at a worksite, comprising:
a central controller communicably coupled with a plurality of production circuits, each of the production circuits comprising at least one production site and at least one dump site, wherein the controller comprises:
one or more processors; and
one or more non-transitory computer-readable media having instructions stored thereon that, when executed by the one or more processors, cause the one or more processors to perform operations comprising:
determining a plurality of production circuits for the worksite, the production circuits comprising one or more activities performed one or more times at the worksite;
determining a production plan for the worksite, the production plan comprising a ranked ordering of the plurality of production circuits;
determining a first allocation of a plurality of work machines to the plurality of production circuits based at least in part on the production plan;
causing the plurality of work machines to distribute to the plurality of production circuits based at least in part on the first allocation;
determining a compliance score describing compliance with the production plan based at least in part on production data describing activity of the plurality of work machines;
determining a second allocation of the plurality of work machines based at least in part on the production plan and the compliance score; and
causing the plurality of work machines to distribute to the plurality of production circuits based at least in part on the second allocation.

2. The system of claim 1, wherein determining the first allocation is based at least in part on a material blend tolerance of material carried by the plurality of work machines to a destination.

3. The system of claim 1, wherein determining the first allocation of the plurality of work machines is further based on energy availability for charging battery electric work machines at production circuits of the plurality of production circuits.

4. The system of claim 1, further comprising determining a material flow rate associated with a production circuit of the plurality of production circuits, and wherein the second allocation is based at least in part on remaining within a threshold range of an average flow rate for the production circuit.

5. The system of claim 1, wherein determining the compliance score comprises:
determining a first work machine of the plurality of work machines causing bunching along a first production circuit of the plurality of production circuits;
determining the second allocation comprises:
reassignment of the first work machine to a second production circuit; and
reassignment of a second work machine from the second production circuit to the first production circuit.

6. The system of claim 1, wherein determining the compliance score comprises:
receiving work machine data from the plurality of work machines;
determining operating parameters describing operating conditions of individual work machines of the plurality of work machines; and
determining the compliance score is further based on the operating parameters being within a predetermined threshold range.

7. The system of claim 1, wherein determining the second allocation comprises:
determining tool delays associated with scheduled down-time for machines at the worksite; and
determining the second allocation is further based at least in part on the tool delays.

8. A method for allocating work machines at a worksite, comprising;
determining, by a processor, a plurality of production circuits for the worksite, the production circuits comprising one or more activities repeated one or more times at the worksite;
determining, by the processor, a production plan for the worksite, the production plan comprising a ranked ordering of the plurality of production circuits;
determining, by the processor, a first allocation of a plurality of work machines to the plurality of production circuits based at least in part on the production plan;
causing, by the processor, the plurality of work machines to distribute to the plurality of production circuits based at least in part on the first allocation;
determining, by the processor, a compliance score describing compliance with the production plan based at least in part on production data describing activity of the plurality of work machines;
determining, by the processor, a second allocation of the plurality of work machines based at least in part on the production plan and the compliance score; and
causing, by the processor, the plurality of work machines to distribute to the plurality of production circuits based at least in part on the second allocation.

9. The method of claim 8, wherein determining the second allocation is further based at least in part on a flow at a station of at least one of the plurality of production circuits by reducing a queue of work machines at the station.

10. The method of claim 8, wherein determining the compliance score comprises:
determining a first work machine of the plurality of work machines causing bunching along a first production circuit of the plurality of production circuits;
determining the second allocation comprises:
reassignment of the first work machine to a second production circuit; and
reassignment of a second work machine from the second production circuit to the first production circuit.

11. The method of claim 8, wherein determining the compliance score comprises:
receiving work machine data from the plurality of work machines;
determining operating parameters describing operating conditions of individual work machines of the plurality of work machines; and
determining the compliance score is further based on the operating parameters being within a predetermined threshold range.

12. The method of claim 8, wherein determining the second allocation comprises:
determining tool delays associated with scheduled down-time for machines at the worksite; and
determining the second allocation is further based at least in part on the tool delays.

13. The method of claim 8, further comprising determining a flow rate associated with a production circuit of the plurality of production circuits, and wherein the second allocation is based at least in part on remaining within a threshold range of an average flow rate for the production circuit.

14. The method of claim 8, wherein determining the first allocation of the plurality of work machines comprises inputting first work machine data and the production plan into a first machine learning algorithm trained to output the first allocation; and
determining the second allocation of the plurality of work machines comprises inputting second work machine data, the production plan, and the compliance score into the first machine learning algorithm to determine the second allocation.

15. The method of claim 14, wherein determining the compliance score comprises using a second machine learning model trained to receive inputs of work machine progress data and operating parameter data and output the compliance score.

16. One or more non-transitory computer-readable media having instructions stored thereon that, when executed by one or more processors, cause the one or more processors to perform operations comprising:
determining a plurality of production circuits for a worksite, the production circuits comprising one or more activities performed one or more times at the worksite;
determining a production plan for the worksite, the production plan comprising a ranked ordering of the plurality of production circuits;
determining a first allocation of a plurality of work machines to the plurality of production circuits based at least in part on the production plan;
causing the plurality of work machines to distribute to the plurality of production circuits based at least in part on the first allocation;
determining a compliance score describing compliance with the production plan based at least in part on production data describing activity of the plurality of work machines;
determining a second allocation of the plurality of work machines based at least in part on the production plan and the compliance score; and
causing the plurality of work machines to distribute to the plurality of production circuits based at least in part on the second allocation.

17. The one or more non-transitory computer-readable media of claim 16, wherein determining the first allocation of the plurality of work machines comprises inputting first work machine data and the production plan into a first machine learning algorithm trained to output the first allocation; and
determining the second allocation of the plurality of work machines comprises inputting second work machine data, the production plan, and the compliance score into the first machine learning algorithm to determine the second allocation.

18. The one or more non-transitory computer-readable media of claim 16, wherein determining the second allocation of work machines comprises using a virtual controller to modify a short-term plan comprising a set of tasks or reconfigure the worksite to increase the compliance score.

19. The one or more non-transitory computer-readable media of claim 18, wherein the set of tasks comprise at least one of:
modifying priorities of the set of tasks;
modifying tasks;
adding tasks;
opening or closing destinations;
pausing or removing tasks; or
requesting relocation of equipment.

20. The one or more non-transitory computer-readable media of claim 18, wherein the virtual controller may determine the set of tasks using at least one of simulation, machine learning, or reinforcement learning.
